(19) United States
(12) Patent Application Publication
(10) Pub. No.: US 2006/0060517 A1
(43) Pub. Date: Mar. 23, 2006

(54) System for automatically filtering floating material from wastewater

(76) Inventor: Ki-Suk Kim, Seoul (KR)

Correspondence Address: MARTINE PENILLA & GENCARELLA, LLP, 710 LAKEWAY DRIVE, SUITE 200, SUNNYVALE, CA, 94085, US

(21) Appl. No.: 11/170,132

(22) Filed: Jun. 28, 2005

(30) Foreign Application Priority Data
Sep. 17, 2004 (KR) 2004-0074735

(51) Int. Cl. B01D 24/46

(52) U.S. Cl. 210/275

(57) ABSTRACT

Disclosed herein is an automatic filtering system, which continuously filters floating material contained in wastewater under automatic control, separately collects the floating material to eliminate the floating material, and continuously discharges filtered water having no floating material. The system includes two sand-type filters and two floating-material collecting tanks each having a pressure sensor which detects internal pressure. One filter and one collecting tank are operated alternately with the other filter and the other collecting tank. Thus, when a filtering performance of one filter is deteriorated, the other sand-type filter is operated. Water filtered by the other filter flows to a filter having a poor filtering performance, thus removing the floating material from the filter, therefore recovering the filtering performance of the filter. Meanwhile, backwashing water containing the floating material is delivered into one collecting tank, so that the floating material is filtered by a filtering net of the collecting tank, prior to being discharged to the outside. The filtered water having no floating material flows into wastewater treatment equipment. When a collecting performance of the filtering net of the collecting tank is deteriorated, the other collecting tank is used.

### BACKGROUND OF THE INVENTION

1. Field of the Invention

The present invention relates to an automatic filtering system, which continuously filters general floating material and fine floating material contained in wastewater or the like under automatic control, separately collects the floating material to eliminate the floating material, and continuously discharges filtered water having no floating material.

2. Description of the Related Art

Generally, individual or common wastewater treatment equipment is required in a place where the amount of discharged wastewater exceeds a predetermined level and the concentration of floating material contained in wastewater exceeds a predetermined level specified by environmental preservation laws, thus filtering floating material contained in wastewater, prior to discharging the wastewater. Such wastewater treatment equipment is usually used for factories or large buildings, for example, hotels or resorts. A floating-material filtering apparatus of the individual or common wastewater treatment equipment used in factories or large buildings is a large floating bath having the shape of a rectangular or circular cavity. The filtering apparatus is operated as follows. That is, wastewater discharged through a relatively narrow wastewater outlet passage flows into the large floating bath. At this time, the flow rate of the wastewater is suddenly reduced, so that the wastewater flows slowly, thus generating turbulence. The amount of floating material mixed with wastewater is reduced by the turbulence. Thereby, material which is lighter than water floats on the wastewater, and the floating material is frequently collected by a mechanical means or a person. In this way, the floating material is eliminated. Meanwhile, if the floating material has large size, the floating material float on wastewater when the flow rate is reduced or the wastewater stops flowing. However, if the floating material, such as fiber or small paper chips, is fine and water soluble, the floating material does not float on the wastewater but settles. Or, the floating material moves along a middle layer of wastewater contained in the floating bath, and some of the floating material may be discharged from the wastewater treatment equipment without being removed. Further, another filtering system has been used to filter floating material of a public bath, a swimming pool, etc. Since water in a bathtub or pool may become dirty due to hair, dirt, etc., thus causing a hygiene problem, the water of the bathtub or pool is forcibly circulated through a sand-type filter by a pump. Thereby, impurities, or floating material, such as hair or dirt, are filtered. In the case of the public bath or swimming pool, the concentration of floating material contained in water is very low. Thus, it takes a long time to block a filtering material of the sand-type filter. Hence, the period between operations of replacing and washing the filtering material so as to recover the performance of the sand-type filter is long. Further, the amount of backwashing water used to wash the filtering material is small. Therefore, the sand-type filter can be efficiently used in the public bath or swimming pool. However, in the case of industrial wastewater, the concentration of floating material is high and the amount of discharged wastewater is large. Thus, in order to maintain the performance of the sand-type filter, the sand-type filter must be repeatedly stopped. Further, in order to wash the filtering material which entraps the floating material during the filtering operation, a large amount of fresh water (industrial water, city water) must be fed into the sand-type filter. Thus, in the event that the sand-type filter is used to filter the industrial wastewater, it is uneconomical and the maintenance of the filter is difficult. For these reasons, the sand-type filter is not used to filter industrial wastewater.

In a detailed description, the size of floating material filtered by the sand-type filter changes according to the size of particles of the filtering material (sand or sand-shaped workpiece). That is, the smaller the particles of the filtering material, the smaller the particles of the filtered floating material. Thereby, it is possible to filter and collect even fine floating material, so that filtering efficiency is high. However, when the size of the particles of the filtering material is small, the density of the filtering material is increased. Thus, the amount of the filtered and collected floating material is increased. In this case, the filtering material is blocked in a short time, so that wastewater does not pass through the filtering material. Thus, the filtering material loses the filtering performance in a short time. In order to reuse the sand-type filter, fresh water is supplied to the filter in a direction opposite to the water flow direction of the filtering operation (this process will be referred to hereinafter as a backwashing-water supply operation), so that the floating material blocking the filtering material is removed and discharged out of the filter. Thereby, the original performance of the filtering material is restored, so that the filtering material can execute the filtering operation again. However, in the event that wastewater of factories or large buildings are filtered using the sand-type filter, the amount of discharged wastewater is large, the concentration of floating material in the wastewater is high, and besides the wastewater contains a large amount of fine floating material. Therefore, the filtering material is frequently blocked, so that the amount of water (city water or industrial water) required for the backwashing-water supply operation is increased, thus it is uneconomical. Further, it is impossible for a worker to judge the period of washing the blocked filtering material, and repeatedly execute the backwashing-water supply operation using a manual manipulation. Thus, the conventional floating bath must be used to filter wastewater of factories or large buildings. The conventional filtering apparatus is problematic in that it requires a large floating bath and a lot of labor, and it is difficult to filter small floating material. Further, it is impossible to adapt the sand-type filter to a waste heat recovery system that recovers waste heat from wastewater.

### SUMMARY OF THE INVENTION

Accordingly, the present invention has been made keeping in mind the above problems occurring in the prior art, and an object of the present invention is to provide a floating-material filtering system, which completely filters fine floating material by having appropriately selected particles of a filtering material, and recovers a filtering performance of the filtering material using an automated backwashing-waster supply operation, thus maintaining constant filtering efficiency without replacing the filtering material for a lengthy period of time, and allows filtered and collected floating material to be separately collected in specified collecting equipment which has at a lower portion thereof a net to discharge water and collect floating material, through the backwashing-water supply operation. According to the present invention, a filter is washed not by fresh water but by filtered water discharged out of the other filter. Two filters alternately execute a filtering operation and a backwater-washing operation. When one of the filters is blocked, the other filter executes the filtering operation. The blocked filter is washed by the discharged filtered water, thus recovering a filtering performance. Thereinafter, the filter is waiting. Meanwhile, when a filter which executes the filtering operation is blocked, the waiting filter that recovers the filtering performance executes the filtering operation. The blocked filter is washed by discharged filtered water to recover the filtering performance. Such processes are repeated, so that it is possible to reuse the filters without stopping the system. Water for the backwashing-water supply operation does not use general fresh water (industrial water, tap water) but uses filtered water of the filter which executes the filtering operation. The backwashing-water which is used to wash the filter and contains a high concentration of floating material passes through a floating-material collecting tank, so that the floating material is collected in the collecting tank. According to this invention, two floating-material collecting tanks are used. Thus, when the amount of floating material collected in one collecting tank exceeds a predetermined level, backwashing water passes through the other collecting tank so that the floating material is collected in the collecting tank. The floating-material collecting tanks are alternately used. Further, if the floating-material collecting tank collects a predetermined amount of floating material, a filtering net of the collecting tank is replaced with another one, thus removing the collected floating material. Further, a hydraulic sensor is installed at a position around an inlet of each of the filters and the floating-material collecting tanks. The hydraulic sensor allows a user to confirm the alternation period and the net replacement period, thus realizing the automation of the system, and allowing the system to be continuously operated.

In order to accomplish the above objects, the present invention provides a system for automatically filtering floating material from wastewater, including two sand-type filters and two floating-material collecting tanks each having a pressure sensor which detects internal pressure, wherein one filter and one collecting tank are operated alternately with the other filter and the other collecting tank. Thus, when the filtering performance of one filter is deteriorated, the other sand-type filter is operated. Water filtered by the other filter flows to the filter having a poor filtering performance, thus removing the floating material from the filter, therefore recovering the filtering performance of the filter. Meanwhile, backwashing water containing the floating material is delivered into one collecting tank, so that the floating material is filtered by a filtering net of the collecting tank, prior to being intermittently discharged to the outside. The filtered water having no floating material flows into final wastewater treatment equipment. When the collecting performance of the filtering net of the collecting tank deteriorates, the other collecting tank is used.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view to show the construction and arrangement of an automatic filtering system and the flow of wastewater in the system, according to the present invention;

FIG. 2 is a view to show the flow of wastewater in the system, according to the present invention, when a filter of the system substitutes for the other filter;

FIG. 3 is a view to show the flow of wastewater in the system during a backwashing-water supply operation, according to the present invention;

FIG. 4 is a view to show the filtered-water flow of a sand-type filter of the system, according to the present invention; and

FIG. 5 is a view to show the backwashing-water flow of the sand-type filter of the system, according to the present invention.

### DESCRIPTION OF THE PREFERRED EMBODIMENTS

Herein, wastewater which is not filtered by a filter is designated as raw water, and wastewater which is filtered by a filter or a floating-material collecting tank is designated as filtered water. Further, filtered water flows into a filter in a direction opposite to the water flowing direction of a filtering operation, and washes floating material trapped by the filtering material of the filter. Through such a process, the water having a high concentration of floating material is obtained. The water is designated as backwashing water.

A system for automatically filtering floating material of wastewater according to the preferred embodiment of the present invention will be described in detail with reference to the accompanying drawings. The drawings represent the path of wastewater flowing along pipes by solid lines and dotted lines. The dotted lines show the state where the pipes are closed by valves so that wastewater or the like does not flow, whereas the solid lines show the state where wastewater flows along the pipes. Further, it is to be understood that phraseology or terminology employed in the specification and claims is for the purpose of description and not of limitation.

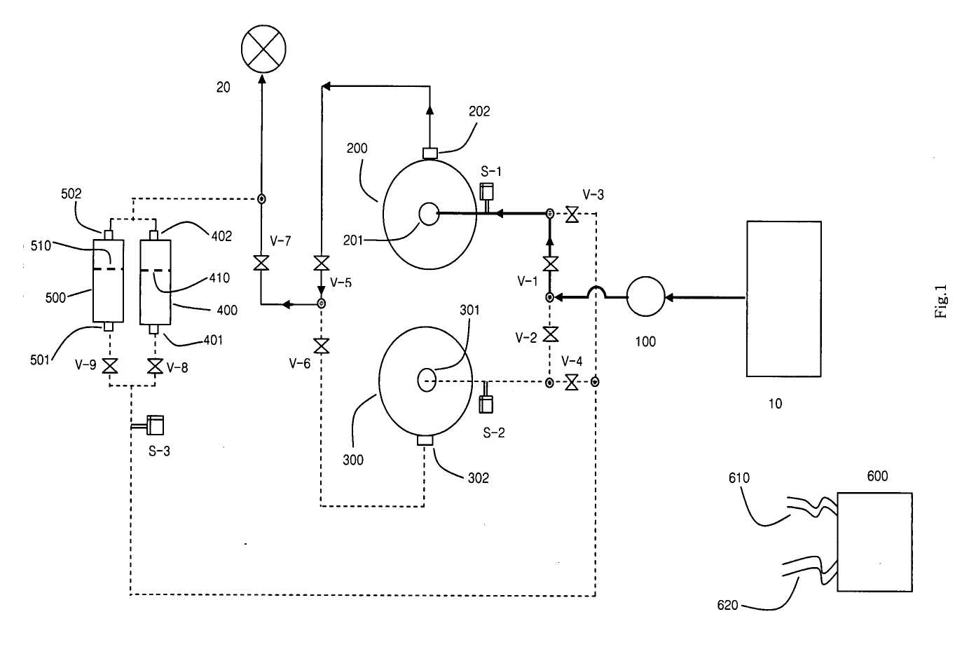

As shown in FIG. 1, the automatic filtering system of this invention includes a wastewater feeding pump 100 which pumps raw water to send the water to a filter 200 or 300. Two sand-type filters 200 and 300 filter the raw water to remove floating material from the raw water. Two floating-material collecting tanks 400 and 500 remove floating material from backwashing water which is discharged after recovering the filtering performance of a filter having deteriorated filtering performance, using filtered water. Further, a plurality of valves is installed on pipes which connect several components to each other, thus controlling the flow of wastewater. The automatic filtering system also includes two pressure sensors S-1 and S-2 that detect internal pressure of the filters 200 and 300, and a pressure sensor S-3 that detects pressure of wastewater fed into the two floating-material collecting tanks 400 and 500. An automatic control panel 600 functions to control the opening and closing of the valves and the operation of the components, based on data from the pressure sensors.

The pressure sensors S-1 and S-2 are installed on portions around water inlets 201 and 301 of the sand-type filters 200 and 300, and are connected to the automatic control panel 600 via sensor signal transmission lines 610. Further, first and second automatic control valves V-1 and V-2 are installed on pipes branching from the water inlets 201 and 301. Pipes extend from the water inlets 201 and 301 of the two sand-type filters 200 and 300 and are connected to each other by a first circulation pipe P-1. Third and fourth automatic control valves V-3 and V-4 are installed on pipes which are connected to the water inlets 201 and 301.

Water outlets 202 and 302 of the sand-type filters 200 and 300 are connected to each other via a common pipe to share the flow of wastewater, thus providing a second circulation pipe P-2. A pipe branches from the second circulation pipe P-2 and is connected to wastewater treatment equipment or waste heat recovery equipment 20. Further, fifth and sixth automatic control valves V-5 and V-6 are provided on the pipe which connects the water outlets 202 and 302 to each other such that the valves are located at predetermined positions spaced from a junction. Further, a seventh automatic control valve V7 is provided on the pipe which connects the second circulation pipe P-2 to the wastewater treatment equipment or waste heat recovery equipment 20.

A pipe branches from the first circulation pipe P-1 to be connected to the two floating-material collecting tanks 400 and 500, and is connected to the pipe which connects the second circulation pipe P-2 to the wastewater treatment equipment or waste heat recovery equipment 20.

The water inlets 201 and 301 are connected via a common pipe and the water outlets 202 and 302 are connected via a common pipe to share the flow of the wastewater. On the connecting pipes are installed the automatic control valves V-1 to V-7 which are opened or closed in response to valve control signals output from the automatic control panel 600 that has received signals from the pressure sensors S-1 and S-2. Further, automatic control valves V-8 and V-9 are installed on pipes that connect the water outlets 202 and 302 of the sand-type filters 200 and 300 and water inlets 401 and 501 of the collecting tanks 400 and 500 that collect floating material filtered by the sand-type filters 200 and 300. The automatic control valves V-1 to V-7 are connected to the automatic control panel 600 via valve control lines 620. Thus, the automatic control panel 600 reads signals output from the pressure sensors S-1 and S-2, thus controlling the operation of the automatic control valves V-1 to V-7 according to a preset program. Meanwhile, the automatic control valves V-8 and V-9 are connected to the automatic control panel 600 via the valve control line 620. Thus, the automatic control panel 600 reads a signal output from the pressure sensor S-3, thus controlling the operation of the automatic control valves V-8 and V-9 according to a preset program.

The automatic filtering system constructed as described above filters and collects floating material contained in the raw water of wastewater or water used in a swimming pool or the like, thus supplying filtered water to the wastewater treatment equipment or waste heat recovery equipment that may malfunction due to the floating material. Therefore, the present invention allows the wastewater treatment equipment or waste heat recovery equipment to be efficiently used, thus maximizing economic efficiency. The operation of the automatic filtering system according to this invention will be described below.

As shown in FIG. 1, the system of this invention sends raw water from a wastewater tank 10 to one filter 200 using the pump 100, thus filtering floating material. The filtered water is delivered into the wastewater treatment equipment or waste heat recovery equipment 20.

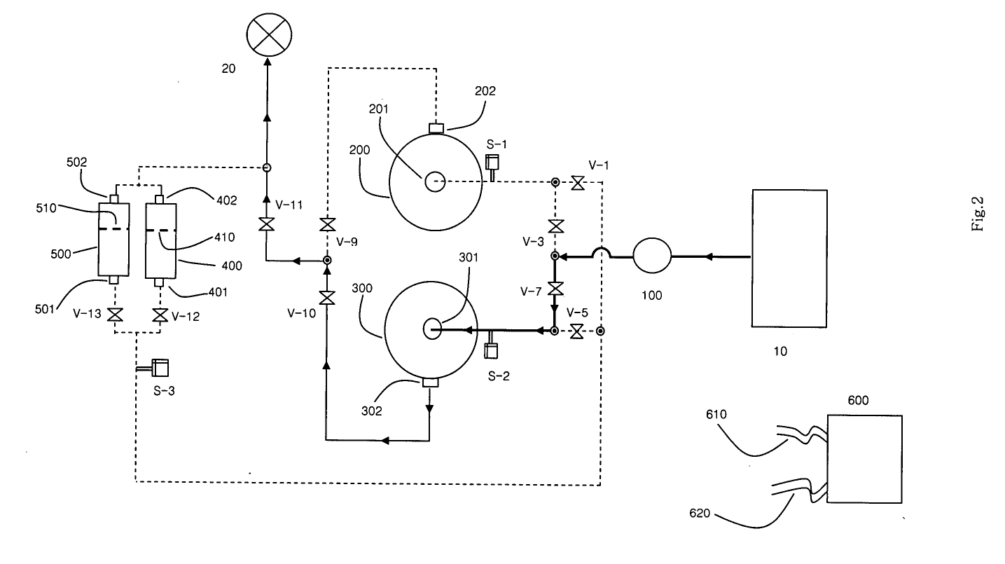

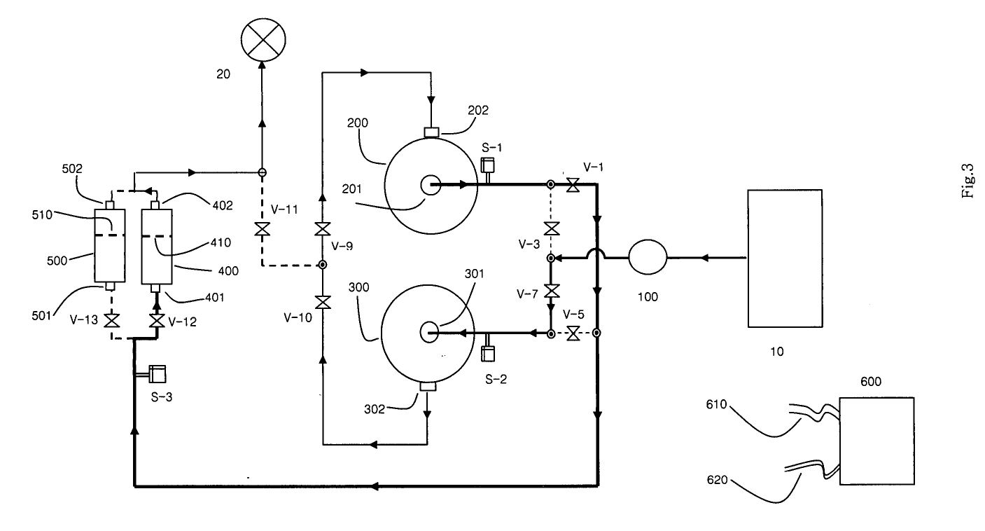

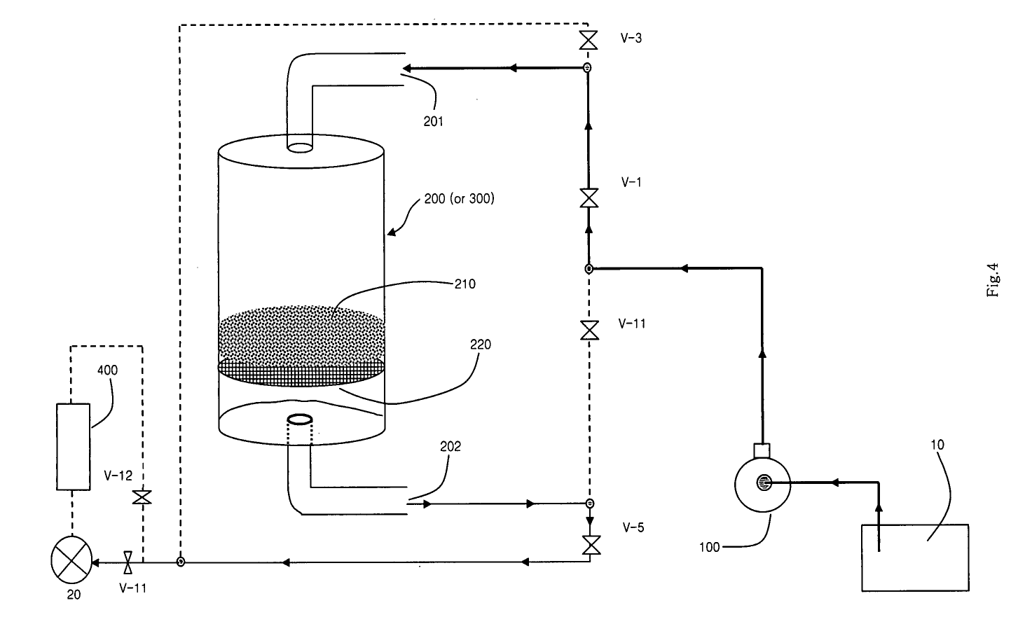

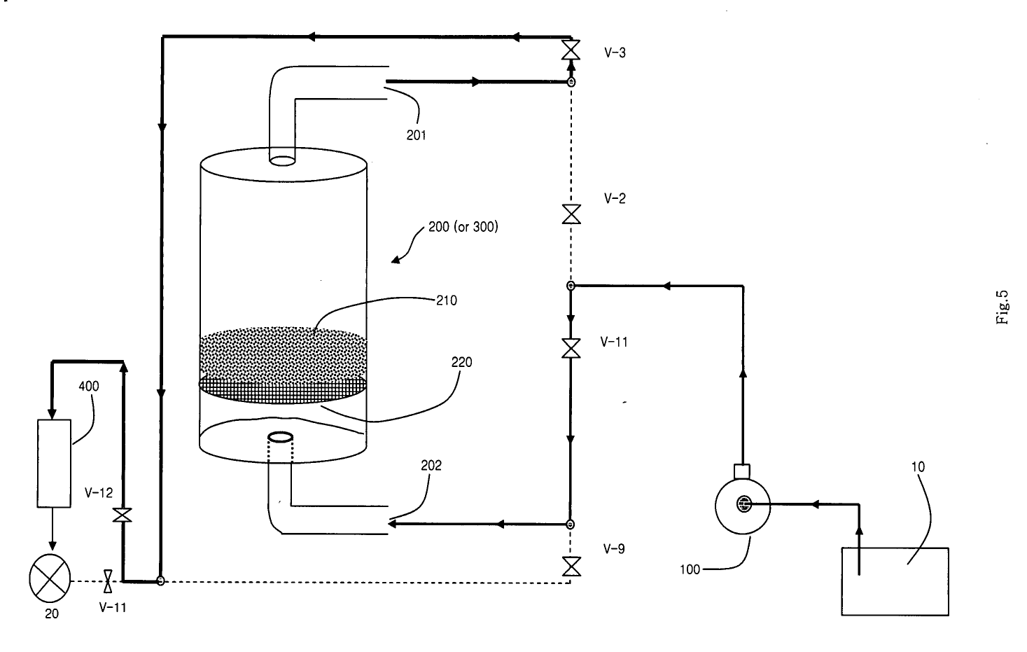

As shown in FIG. 4, the filter 200 filters the raw water using a filtering material 210, such as sand. When filtering a predetermined amount of raw water, the floating material entrapped by the filtering material 210 blocks holes of the filtering material 210, so that the amount of raw water passing through the filtering material 210 is greatly reduced. Thus, the filtering performance of the filter 200 is deteriorated. The filtering performance of the filter 200 is confirmed by measuring increased hydraulic pressure, using the pressure sensor S-1 which is installed on a portion around the water inlet 201. When the hydraulic pressure exceeds a preset value, the filter 200 stops operating. As shown in FIG. 2, raw water is delivered into the other filter 300 which is waiting, so that the raw water is filtered. In order to recover the filtering performance of the blocked filter 200, the prior art uses the following method. That is, fresh water is supplied to the blocked filter in a direction opposite to the water flow direction of the filtering operation, thus washing the filtering material. However, according to this invention, as shown in FIG. 3, the filtering material 210 of the blocked filter 200 is washed not by fresh water but by filtered water obtained by the other filter 300. That is, as shown in FIG. 5, filtered water of the other filter 300, having floating material smaller than holes of a filtering-material support net 320 or having no floating material, are delivered into the water outlet 202 of the blocked filter 200, thus removing the floating material entrapped by the filtering material 210, therefore producing backwashing water containing a high concentration of floating material. Thereafter, the backwashing water is discharged out of the filter 200. In this way, the filtering performance of the blocked filter 200 is recovered.

The backwashing water, which recovers the filtering performance of the blocked filter 200 and is discharged from the water inlet 201 of the blocked filter 200, is delivered into one floating-material collecting tank 400, so that floating material is filtered by a filtering net 410. The filtered water is delivered into the wastewater treatment equipment or waste heat recovery equipment 20 (see, FIG. 3). Similarly to the filters 200 and 300, when one floating-material collecting tank 400 is blocked and the collecting performance of the collecting tank 400 is deteriorated, the other floating-material collecting tank 500 which is waiting will be used. Alternatively, by replacing the filtering net. 410 of the blocked floating-material collecting tank 400 with a new one or washing the filtering net 410 so as to recover the filtering performance of the collecting tank 400, it is possible to reuse the collecting tank 400. Further, the automatic control panel 600 determines whether the floating-material collecting tank 400 which is in use continues to execute the filtering operation, based on the hydraulic pressure, detected by the pressure sensor S-3 which is installed around a backwashing-water inlet, and preset hydraulic pressure. The result, determined by the automatic control panel 600, is output in the form of a warning signal or the like.

As described above, the present invention provides a system for automatically filtering floating material of wastewater, which allows a sand-type filter to filter even fine floating material by having appropriately selected particles of a filtering material, and allows filtering performance of the filter to be recovered due to a backwashing-water supply operation, thus maintaining constant filtering efficiency without replacing the filtering material, therefore solving the problems of a conventional filtering system which requires frequent replacement of a filtering material and is inefficient in costs and maintenance. Further, filtered and collected floating material is separately collected in specified collecting equipment which has a net-type or particle-type filtering material to discharge filtered water and collect large floating material, that is, a floating-material collecting tank, through the backwashing-water supply operation. According to this invention, water filtered by the filter is used for the backwashing-water supply operation, so that this invention solves the problem of the conventional filtering system which requires a large amount of fresh water during the backwashing-water supply operation, thus lightening the burden of expense, and saving energy.

Particularly, the filtering system according to this invention has the following advantages. That is, the system is constructed so that two filters and two floating-material collecting tanks are alternately used, the filter alternation period and the tank alternation period are determined, based on hydraulic pressure detected by pressure sensors which are installed on portions of pipes around water inlets, and the alternating operation is carried out by controlling a plurality of automatic control valves provided on the pipes of the system. Therefore, the system of this invention allows all of the operation to be automatically controlled, thus efficiently executing a wastewater filtering operation. Particularly, the system of this invention uses two sand-type filters, so that filtering performance of a blocked filter can be recovered due to a backwashing-water supply operation. Thereby, it is possible to widely apply the sand-type filter to various fields.

The automatic filtering system of this invention is used in place of a floating bath which is included in conventional wastewater treatment equipment and occupies a large space, so that the space for installing the system is significantly reduced, thus maximizing space utilization. Further, when the conventional floating bath is used, fine floating material or water-penetrable floating material, such as fiber chips or hair, are contained in discharged water, thus causing environmental pollution. However, according to this invention, by appropriately selecting filtering material of the filters and filtering nets of the floating-material collecting tanks, it is possible to filter all fine floating material and water-penetrable impurities of desired sizes. Thus, it is possible to avoid infracting various regulations, such as fines, business closure, and business license cancellation, due to violating environmental standards. Further, when the system of this invention is used for equipment for recovering waste heat of wastewater, it prevents a heat exchanger from being blocked by floating material, and a time and a cost required to wash the heat exchanger are reduced. In brief, the system according to this invention enhances energy efficiency during the wastewater treatment, thus saving energy, and prevents fine floating material and water-penetrable floating material from being discharged, thus preventing environmental pollution.

What is claimed is:

1. A system for automatically filtering floating material from wastewater, comprising:
a wastewater feeding pump to pump raw wastewater;
first and second sand-type filters each having on a wastewater inlet side thereof a pressure sensor to detect internal pressure of each of the filters;
first and second floating-material collecting tanks having on a wastewater inlet side thereof a pressure sensor to detect internal pressure of the first and second floating-material collecting tanks;
a plurality of pipes to connect components of the system to each other;
a plurality of valves provided on the pipes, and automatically controlled to open or close the pipes; and
an automatic control panel to control opening and closing operations of the valves, based on data output from the pressure sensors, wherein
a first pair of filter and floating-material collecting tank alternates with a second pair of filter and floating-material collecting tank, by opening or closing the valves in response to the internal pressures detected by the pressure sensors, thus controlling flow of the raw wastewater,
when filtering performance of the first sand-type filter is deteriorated, the second sand-type filter substitutes for the first sand-type filter, and water filtered by the second filter flows to a filtered water outlet of the first filter having the poor filtering performance, thus washing the first filter and removing floating material from a filtering material of the first filter, therefore recovering the filtering performance of the first filter,
backwashing water, containing the floating material removed from the first filter, is delivered to the first floating-material collecting tank so that the floating material is collected by a filtering net of the first floating-material collecting tank, and the second floating-material collecting tank substitutes for the first floating-material collecting tank, when it is determined that the collecting performance of the first floating-material collecting tank is deteriorated, based on data output from the pressure sensor provided on an inlet side of the first floating-material collecting tank,
when collecting performance of the first and second floating-material collecting tanks is deteriorated due to collected floating material, a filtering net of each of the first and second collecting tanks is replaced with a new one, thus recovering the collecting performance of each of the first and second floating-material collecting tanks, and
filtered water, treated by the first and second sand-type filters and the first and second floating-material collecting tanks so that floating material is removed from the water, is delivered to wastewater treatment equipment.
